(19) United States
(12) Patent Application Publication
(10) Pub. No.: US 2022/0316637 A1
(43) Pub. Date: Oct. 6, 2022

(54) DOUBLE TAPER CONNECTOR

(71) Applicant: VARCO I/P, INC., Wilmington, DE (US)

(72) Inventor: David Wayne Granderson, San Antonio, TX (US)

(21) Appl. No.: 17/595,696

(22) PCT Filed: May 22, 2020
(86) PCT No.: PCT/US2020/034352

§ 371 Date: Nov. 22, 2021

Related U.S. Application Data
(60) Provisional application No. 62/851,869, filed on May 23, 2019.

(51) Int. Cl. F16L 33/22

(52) U.S. Cl. CPC F16L 33/222; F16L 33/224

(57) ABSTRACT

A pipe connection for connecting pipe or terminating pipe may include a mandrel with an insertion portion configured for inserting into an open end of a pipe and including a head. The pipe connection may also include a slip for bitingly engaging an outer surface of the pipe and having a first tapered portion and a second tapered portion. The pipe connection may also include a sleeve having cam surfaces for engaging the first and second tapered portions and a head engaging portion for securing the sleeve to the head.

### CLAIM OF PRIORITY

This patent application claims the benefit of priority to U.S. Provisional Application Ser. No. 62/851,869, filed May 23, 2019, which is incorporated by reference herein in its entirety.

### TECHNOLOGICAL FIELD

The present disclosure relates to a system and method for splicing, coupling, connecting or terminating piping, tubing, or other elongated elements with a longitudinal lumen. More particularly, the present disclosure relates to a system and method for connecting composite, concrete, or other relatively non-ductile piping. Still more particularly, the present disclosure relates to a system and method for connecting composite pipe sections with a mandrel and a slip having a double taper.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Composite piping continues to become more prevalent for piping projects including underground water supply systems, petroleum or crude oil conveying systems and the like. The connections between segments of composite pipe may be designed to resist several different types of forces including ground movements and forces due to motion of fluids through the piping. However, in the context of composite piping, and where internal pressures are relatively high, the longitudinal shrinkage of the piping may be relative large to accommodate the swelling-type expansion of the piping. In the context of composite piping, this longitudinal shrinkage may be relatively high as compared to other types of piping. As such, the connections between the piping may be see relatively high longitudinal tensile forces. Moreover, the material of the composite piping does not lend itself toward welding or other relatively strong connection approaches that may be used for steel or alloy piping, for example.

Connections between segments of composite pipe have, historically, included a few different configurations. There have been single use metallic connectors that are mechanically crimped in place, for example. However, these connectors may require large equipment and/or tools for installation, may fail to maintain their connection forces, may not be easily disconnected, and may not be reusable. Other connections may include slip connections with a mandrel and sleeve for securing sections of pipe to one another or for providing piping terminations.

### SUMMARY

The following presents a simplified summary of one or more embodiments of the present disclosure in order to provide a basic understanding of such embodiments. This summary is not an extensive overview of all contemplated embodiments, and is intended to neither identify key or critical elements of all embodiments, nor delineate the scope of any or all embodiments.

In one or more embodiments, a pipe connection for connecting pipe or terminating pipe may include a mandrel with an insertion portion configured for inserting into an open end of a pipe and including a head. The pipe connection may also include a slip for bitingly engaging an outer surface of the pipe and having a first tapered portion and a second tapered portion. The pipe connection may also include a sleeve having cam surfaces for engaging the first and second tapered portions and a head engaging portion for securing the sleeve to the head.

In one or more embodiments a pipeline for transporting fluid may be provided. The pipeline may include a plurality of pipes in fluid communication with one another to transport a fluid. The pipeline may also include a pipe connection connecting the pipes at each connection between the plurality of pipes. The connection may include a mandrel comprising an insertion portion configured for inserting into an open end of a pipe and comprising a head. The connection may also include a slip for bitingly engaging an outer surface of the pipe and having a first tapered portion and a second tapered portion The connection may also include a sleeve having cam surfaces for engaging the first and second tapered portions and a head engaging portion for securing the sleeve to the head.

In one or more embodiments, a slip for a pipe connection may include a substantially cylindrical inner surface adapted for biting into an outside surface of a pipe and having a plurality of teeth. The slip may also include an outside surface with a proximal tapered portion and a distal tapered portion. The distal tapered portion may be offset radially from the proximal tapered portion.

While multiple embodiments are disclosed, still other embodiments of the present disclosure will become apparent to those skilled in the art from the following detailed description, which shows and describes illustrative embodiments of the invention. As will be realized, the various embodiments of the present disclosure are capable of modifications in various obvious aspects, all without departing from the spirit and scope of the present disclosure. Accordingly, the drawings and detailed description are to be regarded as illustrative in nature and not restrictive.

### BRIEF DESCRIPTION OF THE DRAWINGS

While the specification concludes with claims particularly pointing out and distinctly claiming the subject matter that is regarded as forming the various embodiments of the present disclosure, it is believed that the invention will be better understood from the following description taken in conjunction with the accompanying Figures, in which:

FIG. 1 is a perspective break away view of a composite pipe connection including a mandrel, a slip, and a sleeve, according to one or more embodiments.

FIG. 2 is a side view of the termination of FIG. 1.

FIG. 3 is a side view of a mandrel of the connection of FIG. 1

FIG. 4 is a side view of a slip of the connection of FIG. 1.

FIG. 5 is a side view of a sleeve of the connection of FIG. 1.

FIG. 6 is cross-section view of a pipe connection including a slip with a single taper.

FIG. 7 is a cross-section view of a pipe connection showing the failure of a slip with a single taper.

FIG. 8 is a cross-section view of a pipe connection including a slip with a double taper, according to one or more embodiments.

FIG. 9 is a cross-section view of a pipe connection, according to one or more embodiments.

FIG. 10 is a perspective view of a sleeve of the connection of FIG. 9.

FIG. 11 is a perspective view of a first portion of a slip of the connection of FIG. 9.

FIG. 12 is a perspective view of a second portion of a slip of the connection of FIG. 9.

FIG. 13 is a perspective view of a third portion of a slip of the connection of FIG. 9.

FIG. 14 is a cross-section view of a mandrel of the connection of FIG. 9.

FIG. 15 is a cross-section view of a pipe connection, according to one or more embodiments.

FIG. 16 is a cross-section view of a mandrel of the connection of FIG. 15.

FIG. 17 is a cross-section view of a sleeve of the connection of FIG. 15.

FIG. 18 is a cross-section view of a multi-part slip of the connection of FIG. 15.

FIG. 19 is a cross-section view of the slip of FIG. 18.

### DETAILED DESCRIPTION

The present disclosure, in one or more embodiments, relates to a high-pressure pipe joining or connection system that provides for a substantially uniform engagement around the perimeter of the end of a composite pipe allowing for a secure, removable, and reusable connection that does not damage the pipe end. In particular, the connection may include a mandrel for supporting the pipe wall from the inside, a slip for biting into the outside surface of the pipe, and a sleeve. The slip may include a double taper on its outer surface that functions to maintain the slip in a parallel arrangement with the outside surface of the pipe when the pipe is under tension, thereby maintaining a more uniform biting force into the outside surface of the pipe. Composite pipe may have a tendency to shorten relatively drastically when the pipe is under pressure to compensate for expansion due to the internal pressure. As such, the connections of composite pipe may commonly experience relatively high tension forces. The presently disclosed connection may accommodate these tension forces without damaging the pipe and allowing for a secure connection that is removable and reusable for the same or similar pipe connections. As such, the presently disclosed connection may solve one or more of the several problems found in the prior art systems, particularly as it relates to high-pressure composite pipe joining systems.

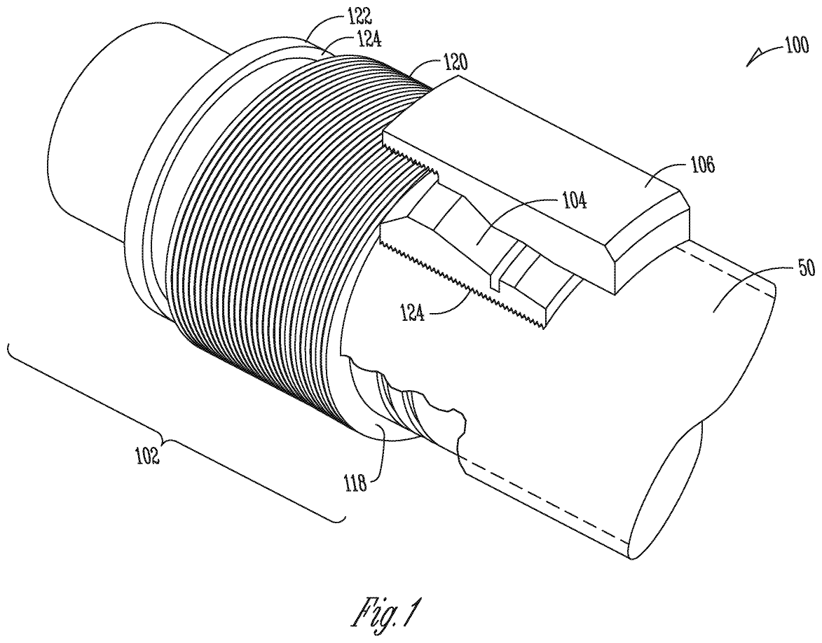

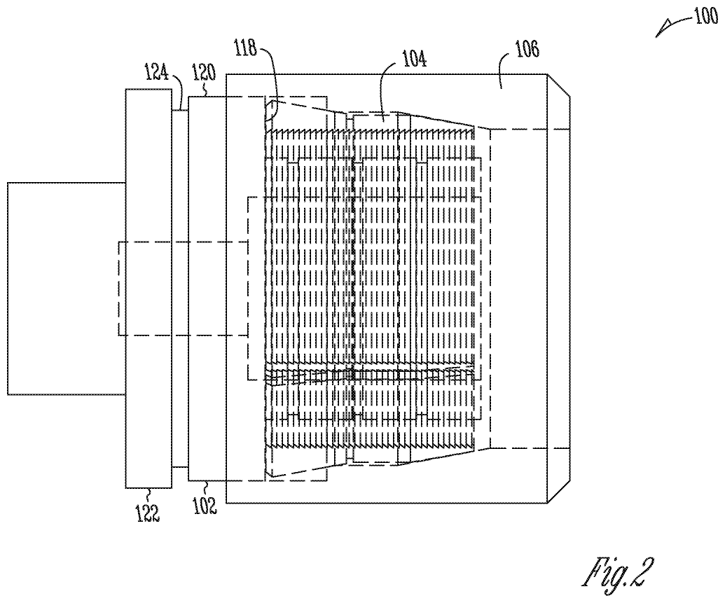

Referring to FIGS. 1 and 2, a composite pipe connection 100 in the form of a termination is shown. The connection 100 of a composite pipe 50 may be configured to secure and seal the pipe end. Moreover, the connection 100 may be configured to do so without damaging the pipe 50 and allowing for removal and reuse of the connection elements. In one or more embodiments, the connection 100 may include a mandrel 102, a slip 104, and a sleeve 106.

It is to be appreciated that the mandrel 102 may be a double-ended mandrel as opposed to the single-ended mandrel shown and, as such, the connection 100 shown could be between two pipes instead of a termination. As such, the below discussion will discuss a single side of a pipe connection 100, which could be part of a termination as shown or it could be part of a connection between two pipe ends where the insertion portion of the mandrel 102 extends both directions and a slip 104 and sleeve 106 are provided for each pipe, for example.

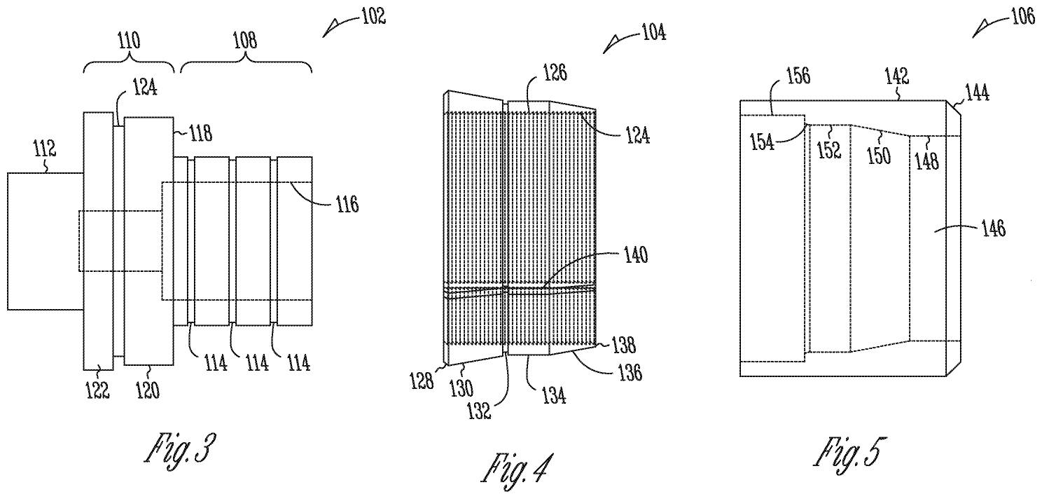

The mandrel 102 may be configured to support the inside of the pipe 50 under the compressive clamping force of the slip 104 and may be configured for sealing the pipe and engaging the sleeve 106, which may maintain the mandrel 102 in the pipe end. As shown, the mandrel 102 may be adapted for snug arrangement inside an end of pipe 50 and it may be relatively rigid and strong to resist the clamping forces and allow for pinching the pipe wall between the slip 104 and the mandrel 102. With reference to FIGS. 1 and 3, the mandrel 102 may include an insertion portion 108 and a head portion 110 and, where the mandrel functions as a termination, the mandrel may also include a cap 112.

The insertion portion 108 of the mandrel 102 may be the portion adapted for insertion within the pipe 50. The insertion portion 108 may, thus, be a cylindrically shaped portion having an outer cylindrical surface with a diameter adapted for relatively snug insertion into a pipe end. The outer surface may include one or more sealing slots 114 adapted to receive resilient sealing rings for sealing against the inside wall of the pipe. In one or more embodiments, the insertion portion may include 1, 2, 3, 4, or more sealing slots 114 for receiving sealing rings. The sealing rings may include O-ring seals for placement in the slots 114. The O-rings may have a thickness slightly larger than the depth of the slots such that when the insertion portion is placed within the pipe end, the O-rings depress slightly to create a seal against the inner wall of the pipe. The O-rings may include resilient polyurethane or other sealing materials. The insertion portion 108 may include a bore 116 extending therethrough to allow fluid to flow through the mandrel 102 in the case of a pipe-to-pipe connection and/or to reduce the weight of the mandrel 102 where it is used as a termination. The insertion portion 108 may have a relatively large wall thickness adapted to resist the compressive forces of the connection while being thin enough to maximize the bore diameter to avoid inhibiting fluid flow. The wall thickness may also be selected to accommodate the sealing ring slots 114. The insertion portion 108 may extend into the pipe end a distance approximately equal to the inside diameter of the pipe. In other embodiments, a longer or shorter insertion portion may be used. The length of the insertion portion and the number of sealing rings may be selected based on the anticipated pressures of the pipe and the amount of sealing desired as well as the diameter of the pipe and other design characteristics of the connection.

The head portion 110 may be arranged on a proximal end of the insertion portion 108 where proximal is toward the pipe end and distal is toward the body of the pipe. That is, the terms distal and proximal may be with respect to the head portion 110. The head portion 110 may include an annular abutment face 118 arranged adjacent to the insertion portion 108. The abutment face 118 may function to stop or limit the amount of insertion of the insertion portion by being larger than the inner pipe diameter and by encountering the pipe end. The annular abutment face 118 may have an inner diameter that is the same or similar to the outer diameter of the insertion portion and may have an outer diameter substantially larger than the inner diameter. The outer diameter may be selected such that the abutment face extends radially outward a distance sufficient to accommodate the pipe wall thickness and the slip thickness. The abutment face may extend radially outward to a sleeve engaging surface 120. The sleeve engaging surface 120 may be a substantially cylindrically shaped surface extending proximally from the outer diameter of the abutment face and the sleeve engaging surface may be adapted for engagement by the sleeve portion. In one or more embodiments, the sleeve portion 106 may be a threaded nut, for example, and the sleeve engaging portion 120 may include a threaded surface for threadably engaging threads on the inside of the nut. In other embodiments, the sleeve engaging surface may include a toothed surface and the sleeve may be a ratcheting device that slips over the sleeve engaging surface with corresponding teeth adapted to allow the sleeve to move proximally across the sleeve engaging surface, but prevent distal motion of the sleeve. Still other surface features may be provided. For example, a cam slot may be provided, where the sleeve may have knobs or nubs on an inner surface that follow a proximally extending track on the outside surface of the sleeve engaging surface until the nubs reach a turn in the track and the sleeve may be turned to cause the nub to continue to follow the track. The track may be sloped away from the insertion portion to draw the sleeve further proximally onto the sleeve engaging portion until the nub reaches a detent or other stoppage point along the track. Still other sleeve engaging features may be provided on the sleeve engaging surface.

The head portion 110 may also include an extension portion 122 arranged proximal to the sleeve engaging surface 120. The extension portion 122 may be adapted to extend beyond the sleeve 106 allowing for physical engagement with the head 110 and allowing the head to be held and/or manipulated relative to the sleeve when the sleeve encompasses or is secured to the sleeve engaging portion. The extension portion 122 may be offset from the sleeve engaging portion by a slot 124 and the extension portion 122 may have an outer diameter similar to the sleeve engaging portion. The sleeve engaging portion and the extension portion may include an inner bore to reduce the weight of the components and/or allow for fluid flow depending on the nature of the mandrel (e.g., termination or pipe connection).

As mentioned, and in the case of a pipe termination, the mandrel may include a cap 112. The cap 112 may be arranged on the proximal side of the extension 122 and may close off the bore extending through the sleeve engaging portion and the extension portion 122. The cap 112 may be relatively small in diameter and may extend proximally from the extension portion 122 forming a gripping cylinder for handling the mandrel 102.

The mandrel and its respective portions may be formed from one or a combination of several materials. In one or more embodiments, the mandrel may include steel, steel alloys adapted for strength and/or corrosion resistance, hardened steel, coated metals (e.g., nickel, epoxy, etc.), stainless steel, corrosion resistant and/or sour resistant alloys, austenitic nickel-chromium-based superalloys such as Inconel®, and/or high chrome. Still other materials may be used.

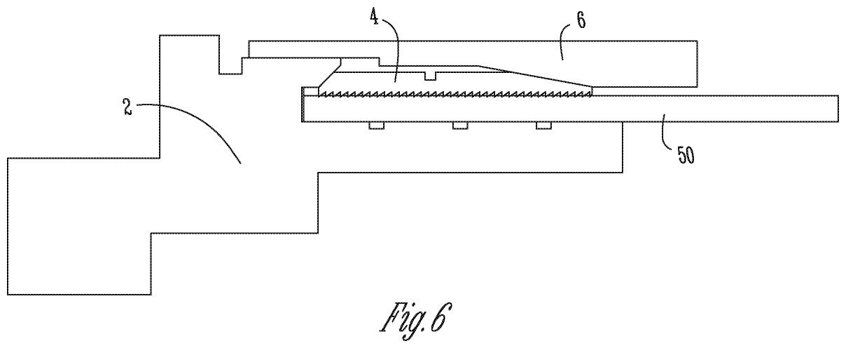

As shown in FIG. 1 and FIG. 4, the slip 104 may be configured for arrangement on the outside surface of the pipe end at or around the area of the insertion portion 108. That is, the slip 104 may be adapted for bitingly pressing on the outside surface of the pipe due to inward pressure or holding pressure exerted by the sleeve 106. The slip 104 may include an inner surface 124 adapted for biting into the outside surface of the pipe. As such, the inner surface 124 may include a substantially cylindrical shape having a diameter the same or similar to the outer diameter of the pipe. The inner surface may include a plurality of biting teeth 126. The teeth 126 may extend around the inner surface. When viewed in cross-section, the teeth may have a proximal surface arranged substantially radially and a distal surface angled upward away from the pipe surface and skewed in a distal direction. As such, the teeth 126 may be adapted for resisting proximal motion along the length of the pipe. The outside surface of the slip 104 may include one or more tapered surfaces adapted to drive the teeth of the slip into the outer surface of the pipe when the slip is urged in a distal direction along the pipe. When viewed from the side as shown in FIG. 4 and moving from the proximal end (e.g., left side in FIG. 4) to the distal end (e.g., right side in FIG. 4), the outer surface may include a chamfered proximal end 128, a proximal tapered portion 130, a slot 132, a cylindrical portion 134, a distal tapered portion 136, and a nose 138.

The chamfered proximal end 128 may provide a rounded corner at the proximal portion of the slip 104 to avoid a sharp edge that may be difficult to handle or otherwise have a tendency to bite into other elements. The proximal tapered portion 130 may be defined by an outer diameter at a proximal side and a smaller outer diameter at a distal side defining a substantially constant slope and forming a taper. The tapered surface may be adapted for engagement by an inner surface of the sleeve such that distal motion of the slip may cause the tapered surface to further engage the sleeve and drive the teeth of the slip into the surface of the pipe. The slot 132 may be arranged distally adjacent to the distal side of the proximal taper. The slot may provide for weight reduction and/or for gripping of the slip when placing the slip on the pipe end. The cylindrical surface 134 may be arranged distally adjacent to the slot and may provide a relatively flat surface adjacent the slot. The distal tapered portion 136 may have an outside diameter at a proximal side that is the same or similar to the outside diameter of the cylindrical portion and a smaller outside diameter at a distal side defining a substantially constant slope and forming a taper. The slope of the proximal tapered portion 130 and the distal tapered portion 136 may be the same and, as such, the surfaces of the tapered portions may be substantially parallel to one another and offset longitudinally and radially. The parallel nature of the tapered portions 130, 136 may help to provide for substantially constant biting forces across all of the teeth of the slip. The nose 138 of the slip may include an annular surface on the distal most portion of the slip and may establish the location of the minimum thickness of the slip.

The slip 104 may include one or more longitudinally extending compression relief slots 140. As shown in FIG. 4, a slot 140 may be provided extending longitudinally along the slip 104 that may allow for the diameter of the slip to be flexible under the squeezing forces of the sleeve. The slot or slots may help to avoid buildup of compressive hoop stresses in the slip that may resist allowing the teeth to bite into the outside of the pipe.

The slip and its respective portions may be formed from one or a combination of several materials. In one or more embodiments, the slip may include steel, steel alloys adapted for strength and/or corrosion resistance, hardened steel, coated metals (e.g., nickel, epoxy, etc.), stainless steel, corrosion resistant and/or sour resistant alloys, austenitic nickel-chromium-based superalloys such as Inconel®, and/or high chrome. Still other materials may be used.

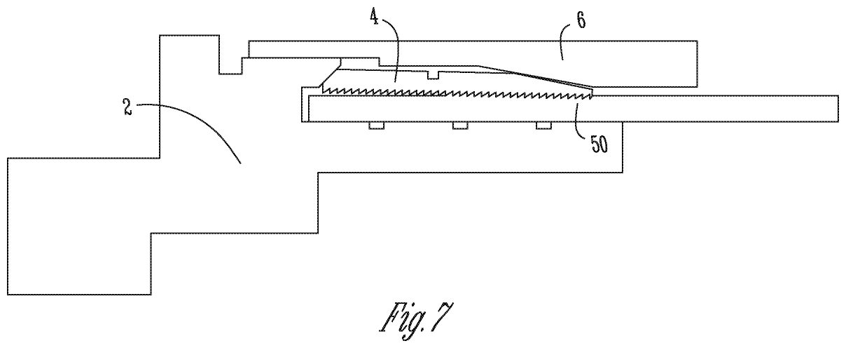

The sleeve 106 is shown in FIG. 5. The sleeve 106 may be adapted for sleeving over the slip 104 and the pipe 50, maintaining the radial position of the slip 104, and for engaging the head 110 of the mandrel 102. The sleeve 106 may include an outer diameter forming a substantially cylindrical surface 142 with a chamfer 144 at a distal end. The sleeve 106 may also include a substantially varying inner bore 146 adapted for engaging the slip 104 and driving the slip into the outer surface of the pipe. As shown, and starting at the distal side (e.g., right side of FIG. 5) and moving to the proximal side (e.g., left side in FIG. 5), the inner bore may include a pipe sleeve portion 148, a distal taper cam 150, a relief portion 152, a proximal taper nose cam 154, and a head engaging portion 156.

The pipe sleeve portion 148 may include a free area adapted to surround the pipe and maintain an offset space between the sleeve and the pipe wall and helping to ensure that unanticipated radial forces are avoided on the sleeve. The free area may, thus, have an inner diameter the same as or slightly larger than the outside diameter of the nose 138 of the slip 104.

The distal taper cam 150 may include a conical inner surface adapted to engage the distal tapered portion 136 of the slip. The conical inner surface may have a slope when viewed in cross-section that is substantially parallel to the tapered portions of the slip. The proximal and distal diameters of the conical portion may be selected to be slightly larger than the respective proximal and distal diameters of the distal tapered portion such that when the sleeve is engaged with the head, some longitudinal motion of the sleeve is allowed before the distal taper cam engages the distal tapered portion.

The relief portion 152 may include a substantially cylindrical portion of the sleeve arranged proximal to the distal taper cam. The relief portion may include an inner diameter larger than the distal tapered portion of the slip and may extend proximally to the proximal taper nose cam 154. That is, the relief portion may create an extension portion reaching proximally to engage the proximal tapered portion 130 of the slip due to the offset nature of the tapered portions of the slip.

The proximal taper nose cam 154 may include a chamfered nose on a proximal end of the relief portion. The chamfered surface may engage the proximal tapered portion 130 and may have a chamfer angle the same or similar to the angle of taper of the tapered portions of the slip. The chamfered surface may slidingly engage the proximal tapered portion as the sleeve is urged proximally and the chamfered nature of the surface may help to avoid biting into the outer surface of the slip.

The proximal taper nose cam 154 may give way to the head engaging portion 156. The head engaging portion 156 may be sized and adapted to engage the sleeve engaging portion 120 of the head 110 to secure the sleeve 106 to the head 110 and prevent distal motion of the sleeve along the pipe. As discussed with respect to the sleeve engaging portion, the sleeve may be in the form of a nut and may include a threaded inner surface adapted to engage the sleeve engaging portion. Other approaches such as a toothed approach, or a cam slot approach may be used as described above.

The sleeve and its respective portions may be formed from one or a combination of several materials. In one or more embodiments, the sleeve may include steel, steel alloys adapted for strength and/or corrosion resistance, hardened steel, coated metals (e.g., nickel, epoxy, etc.), stainless steel, corrosion resistant and/or sour resistant alloys, austenitic nickel-chromium-based superalloys such as Inconel®, and/or high chrome. Still other materials may be used.

In operation and use, the sleeve 106 may be placed on a free end of a pipe with the head engaging portion 156 facing proximally (e.g., toward the free end of the pipe). The slip 104 may be slipped over the free end of the pipe and arranged proximal to the sleeve and such that the proximal face of the slip 104 is approximately flush with the pipe end. The insertion portion 108 of the mandrel may be inserted into the free end of the pipe until the abutment face 118 engages the free end of the pipe. The sleeve 106 may then be moved proximally along the pipe over the slip 104 and the head engaging portion 156 of the sleeve 106 may be secured to the sleeve engaging portion 120 of the head. As the sleeve moves proximally over the slip, the proximal taper nose cam 154 may slidingly engage the proximal tapered portion 130 and the distal taper cam 150 may slidingly engage the distal tapered potion 136. The conical nature of the cam surfaces may squeeze the slip 104 and drive the teeth of the slip into the outer surface of the pipe. Once assembled, internal pressure within the pipe may bias the mandrel 102 out of the end of the pipe and the internal pressure may also cause the pipe to shrink longitudinally. The pressure on the mandrel 102 may pull on the sleeve in a proximal direction and shrinkage of the pipe may pull on the slip in a distal direction. The proximal tendency of the sleeve may increase the squeezing force on the slip due to the tapered surfaces being engaged by the cam surfaces of the sleeve. The distal tendency of the slip may further this action. As such, the higher pressures may induce a higher biting force of the slip on the outer surface of the pipe end. Moreover, the double taper nature of the slip may cause the squeezing force on the slip to be relatively uniform throughout its length and, as such, the teeth biting force on the inner surface of the slip may be substantially uniform throughout the length of the toothed surface.

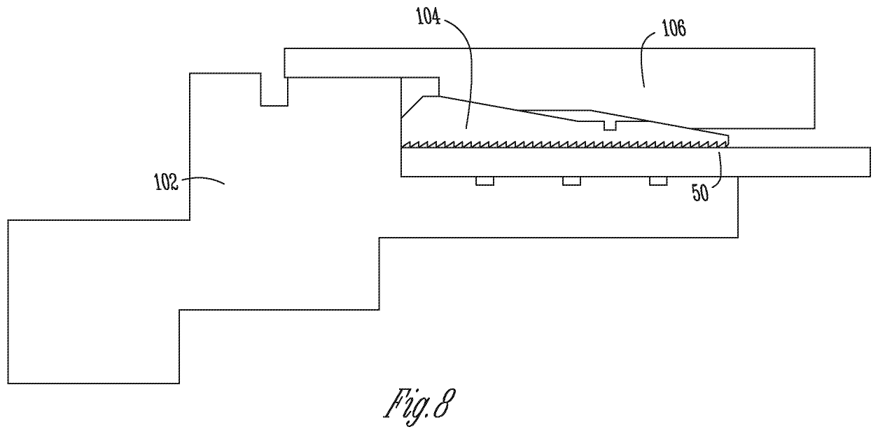

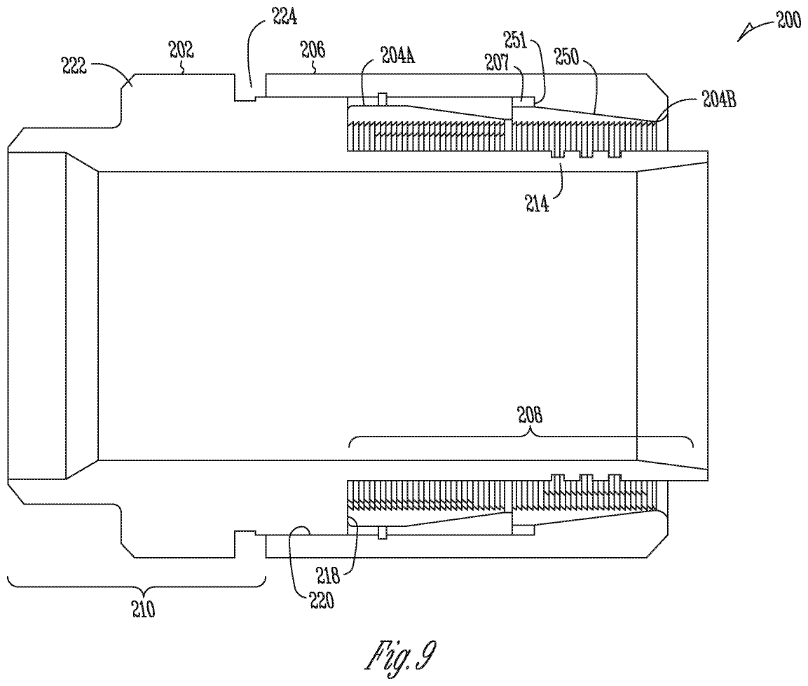

That is, for example, with reference to FIG. 6, a slip 4 with a single tapered arranged toward a distal side of the slip is shown. Under pressure, which may cause the mandrel 2 and the pipe to want to separated longitudinally, the mandrel 2 may pull proximally on the sleeve 6. The proximal pulling motion on the sleeve 6 may cause the sleeve to exert squeezing pressure on the tapered surface. However, because there is no similar squeezing force near the proximal portion of the slip 4, the proximal portion of the slip may deflect outward as shown in FIG. 7. This may cause the biting force of the teeth to be focused at the distal portion of the slip. This may be an inefficient use of the teeth on the slip, but may also create an unduly high biting force in this region, which may damage the pipe surface. In contrast, and as shown in FIG. 8, a similar pressurized condition with a double taper slip, such as that of FIGS. 1-5, may result in a slip that more uniformly engages the outer surface of the pipe.

It is to be appreciated that a single taper slip may be used that extends the full length of the slip. Such a design may also provide for relatively uniform engagement of the slip with the outside wall of the pipe. The proximal portion of the slip in such a design may become relatively thick and may result in a substantially heavy slip. By providing parallel double tapered portions on the slip, the weight of the slip may be considerably less than a slip with a full length single taper. Moreover, for purposes of ease of use and installation, the distal taper may be offset more radially outward than the distal tapered portion thereby striking a balance between providing double tapered portions, but also allowing for ease of assembly.

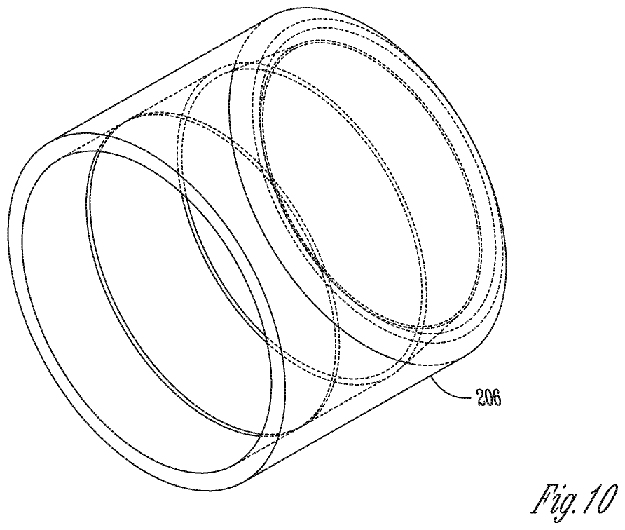

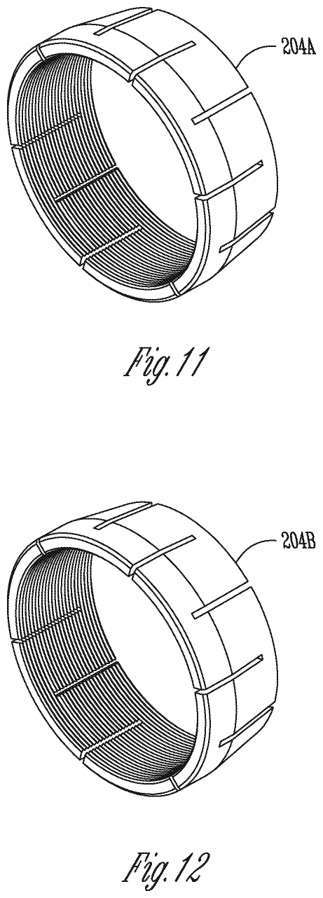

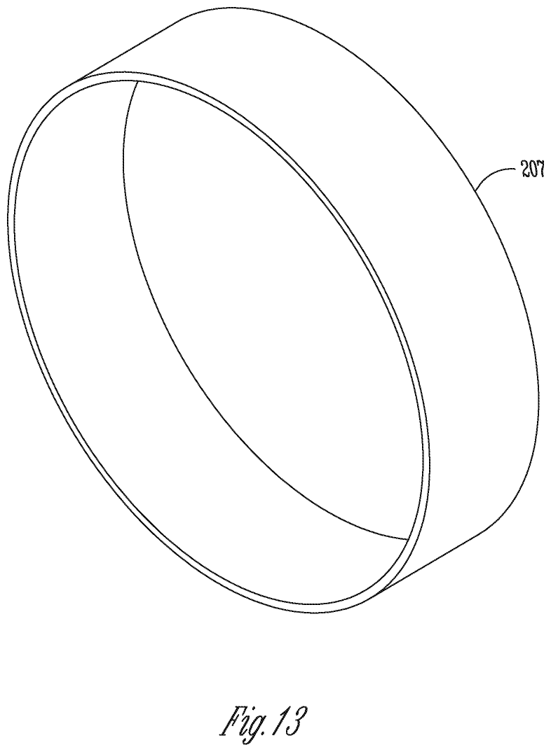

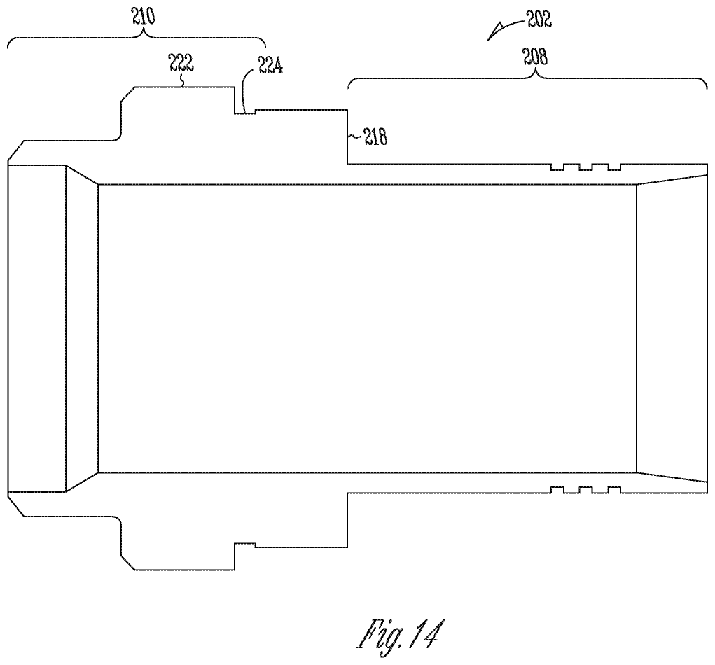

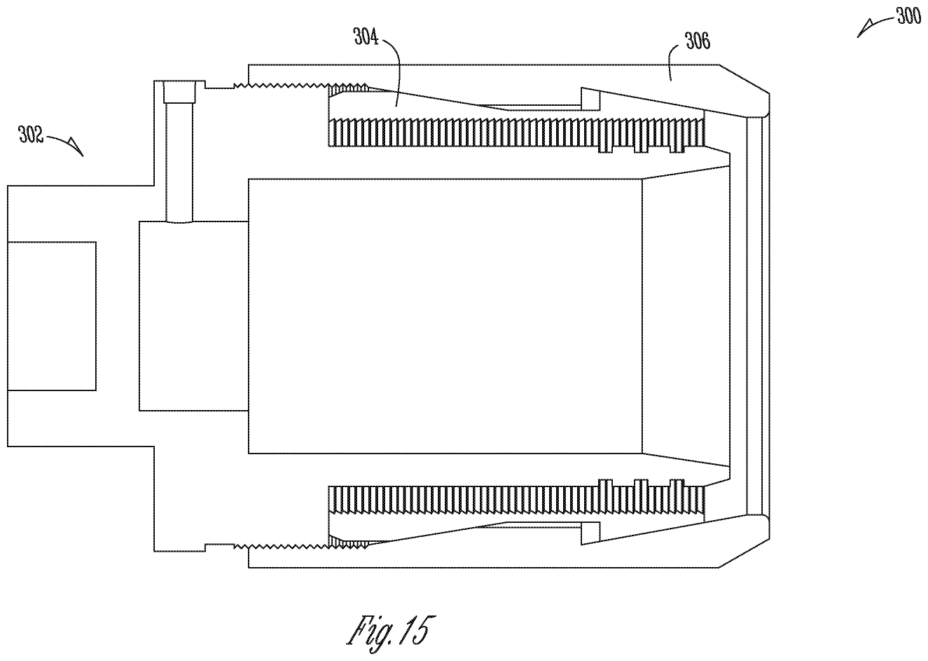

FIGS. 9-14 show another embodiment of a pipe connection 200. In this embodiment, the several features of the connection may be the same or similar to the connection described with respect to FIGS. 1-5. That is, the connection may include a mandrel 202, a slip 204, and a sleeve 206. In addition, the mandrel 202 may include an insertion portion 208 with sealing slots 214 and a head 210. The head may include an abutment surface 218, a sleeve engaging surface 220, a slot 224, and an extension portion 222.

However, in this embodiment, the slip 204 may include a proximal slip 204A and a distal slip 204B. That is, the connection may include two slips configured for consecutive longitudinal arrangement. The slips may also include a cam ring 207 for placement inside the sleeve 206 to engage one of the slips. As shown, in FIG. 9, the sleeve 206 may have a cam surface 250 built into a distal end for engaging the distal slip 204B. However, a separate cam ring 207 may be arranged proximally to this cam surface for engaging the proximal slip 204A. The cam surface on the sleeve may include a proximal shoulder 251 such that if/when the sleeve is advanced proximally over the distal slip to a point where the shoulder extends proximally beyond the distal slip, the shoulder may engage the cam ring 207 causing it to advance and slidingly engage the proximal slip. The present embodiment may be advantageous by having smaller components that may be more manageable particularly as the pipe size and pipe pressures increase.

In this embodiment, it is to be appreciated that the tapered surfaces on the slips may be offset from one another longitudinally, but not radially. This is in contrast to the slip of FIG. 4, where the low point of the proximal tapered portion is at a radial position similar to the top of the distal tapered portion. The separate cam ring may be provided to allow for installation. That is, if the separate cam ring were more permanently arranged on the inside surface of the sleeve, the proximal cam would need to be forced over the distal tapered surface to get into position with the proximal tapered surface. Given the rigidity of the sleeve, this may be difficult. Accordingly, the present embodiment allows for the cam ring to be installed apart from the sleeve and after the installation of the distal slip (e.g., together with the proximal slip). Then, when the sleeve is moved into position over the slips, the separate cam ring is already in place and does not pose an installation problem.

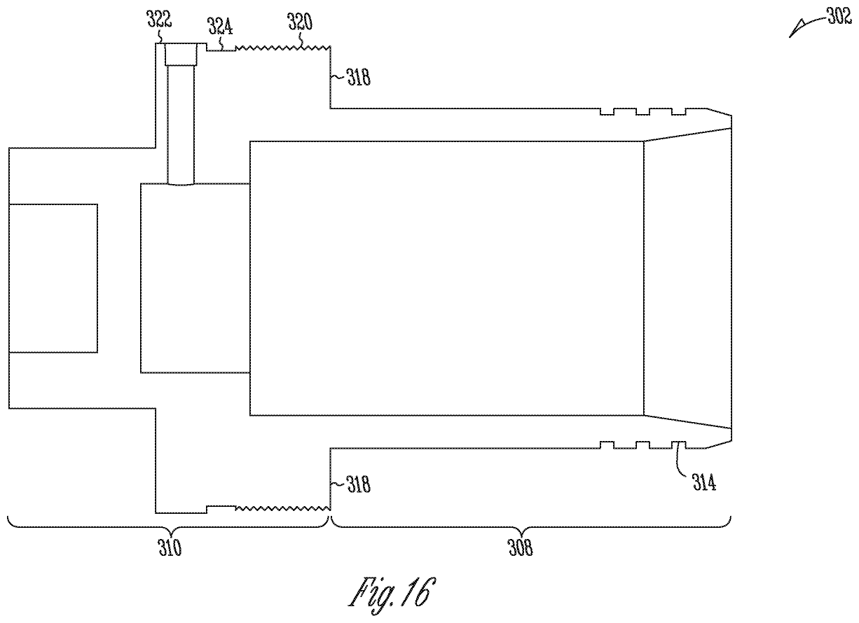

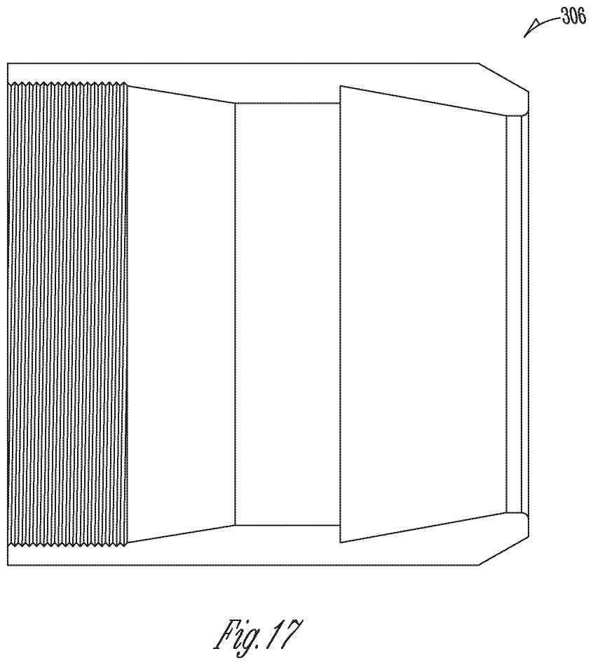

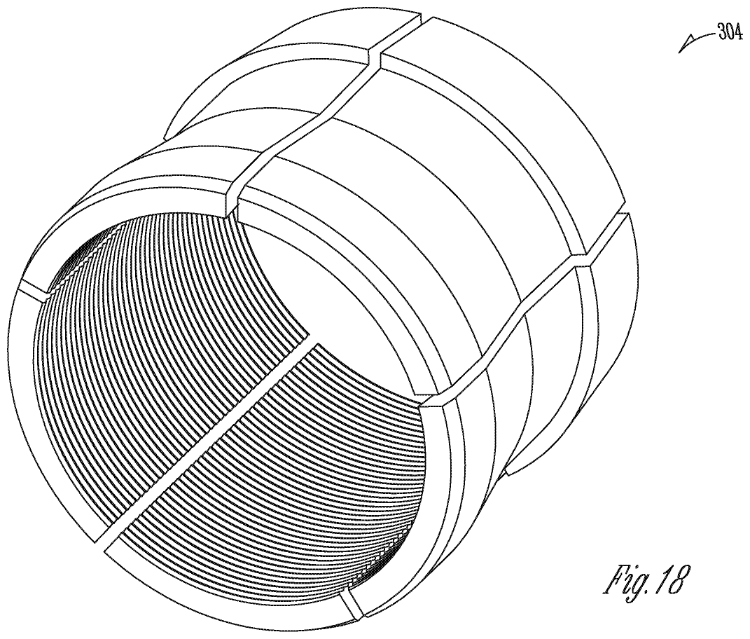

FIGS. 15-19 show yet another embodiment of a pipe connection 300. As with the previous embodiments, the several features of the connection may be the same or similar to the connection described with respect to FIGS. 1-5 and 9-14. That is, the connection may include a mandrel 302, a slip 304, and a sleeve 306. In addition, the mandrel 302 may include an insertion portion 308 with sealing slots 314 and a head 310. The head 310 may include an abutment surface 318, a sleeve engaging surface 320, a slot 324, and an extension portion 322.

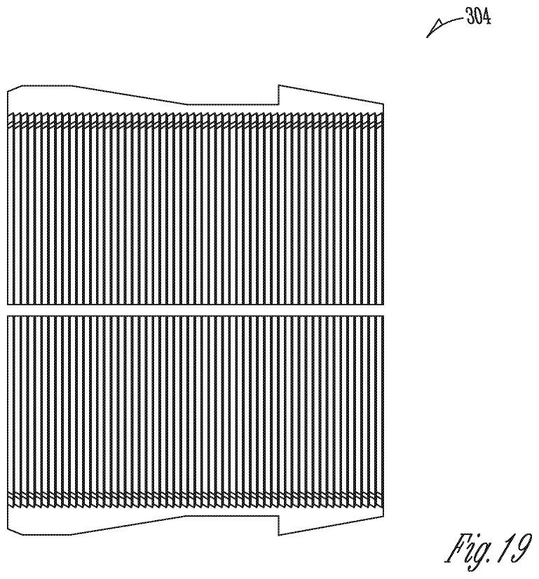

However, in this embodiment, the slip 304 may be provided in a series of split sections around the perimeter of the slip 304. Moreover, and like the embodiment of FIGS. 9-14, the tapered portions of the slip may be offset longitudinally, but not radially. In this embodiment, the internal cam surfaces of the sleeve may be built into the sleeve and arranged accordingly. As shown in FIGS. 18 and 19, the slip may include a plurality of sections configured for arrangement around the periphery of the pipe end. FIG. 19 shows the tapered portions having low points at a similar radial dimension and a high points at a similar radial dimension. This is in contrast to the slip of FIG. 4, where the low point of the proximal tapered portion is at a radial position similar to the top of the distal tapered portion. In this embodiment, the slip may be installed within the sleeve prior to insertion of the pipe because the longitudinally offset tapers may not allow the sleeve to be fully removed from or installed over the slips when the pipe is in position. As such, the slips may be installed in the sleeve and the sleeve may be moved slightly distally relative to the slips so as to avoid causing the teeth to engage the pipe when the pipe is installed. Once the pipe is installed, the mandrel may be installed and the sleeve may be moved proximally relative to the slips to engage the head of the mandrel and cause the slips to bite into the outer surface of the pipe. Like the embodiment of FIGS. 9-14, the present embodiment may be advantageous by having smaller components that may be more manageable particularly as the pipe size and pressures increase.

Although a flowchart or block diagram may illustrate a method as comprising sequential steps or a process as having a particular order of operations, many of the steps or operations in the flowchart(s) or block diagram(s) illustrated herein can be performed in parallel or concurrently, and the flowchart(s) or block diagrams) should be read in the context of the various embodiments of the present disclosure. In addition, the order of the method steps or process operations illustrated in a flowchart or block diagram may be rearranged for some embodiments. Similarly, a method or process illustrated in a flow chart or block diagram could have additional steps or operations not included therein or fewer steps or operations than those shown. Moreover, a method step may correspond to a method, a function, a procedure, a subroutine, a subprogram, etc.

As used herein, the terms “substantially” or “generally” refer to the complete or nearly complete extent or degree of an action, characteristic, property, state, structure, item, or result. For example, an object that is “substantially” or “generally” enclosed would mean that the object is either completely enclosed or nearly completely enclosed. The exact allowable degree of deviation from absolute completeness may in some cases depend on the specific context. However, generally speaking, the nearness of completion will be so as to have generally the same overall result as if absolute and total completion were obtained. The use of “substantially” or “generally” is equally applicable when used in a negative connotation to refer to the complete or near complete lack of an action, characteristic, property, state, structure, item, or result. For example, an element, combination, embodiment, or composition that is “substantially free of” or “generally free of” an element may still actually contain such element as long as there is generally no significant effect thereof.

In the foregoing description various embodiments of the present disclosure have been presented for the purpose of illustration and description. They are not intended to be exhaustive or to limit the invention to the precise form disclosed. Obvious modifications or variations are possible in light of the above teachings. The various embodiments were chosen and described to provide the best illustration of the principals of the disclosure and their practical application, and to enable one of ordinary skill in the art to utilize the various embodiments with various modifications as are suited to the particular use contemplated. All such modifications and variations are within the scope of the present disclosure as determined by the appended claims when interpreted in accordance with the breadth they are fairly, legally, and equitably entitled.

What is claimed is:

1. A pipe connection for connecting pipe or terminating pipe, the pipe connection comprising:
a mandrel comprising an insertion portion configured for inserting into an open end of a pipe and comprising a head;
a slip for bitingly engaging an outer surface of the pipe and having a first tapered portion and a second tapered portion; and
a sleeve having cam surfaces for engaging the first and second tapered portions and a head engaging portion for securing the sleeve to the head.

2. The pipe connection of claim 1, wherein the first tapered portion and the second tapered portion are parallel.

3. The pipe connection of claim 2, wherein the first tapered portion and the second tapered portion are offset longitudinally.

4. The pipe connection of claim 3, wherein the first tapered portion and the second tapered portion are offset radially.

5. The pipe connection of claim 4, wherein the first tapered portion is a distal tapered portion and the second tapered portion is a proximal tapered portion, wherein the proximal tapered portion is arranged at a larger radial distance than the distal tapered portion.

6. The pipe connection of claim 5, wherein the cam surfaces of the sleeve comprise a distal cam surface and a proximal cam nose.

7. The pipe connection of claim 6, wherein the distal cam surface is adapted to slidingly engage the distal tapered surface and the proximal cam nose is adapted to slidingly engage the proximal cam surface.

8. The pipe connection of claim 1, wherein the head comprises an abutment surface immediately adjacent to the insertion portion.

9. The pipe connection of claim 8, wherein the head comprises a sleeve engaging surface.

10. The pipe connection of claim 9, wherein the sleeve comprises a threaded nut and the sleeve engaging surface comprises a threaded surface.

11. The pipe connection of claim 1, wherein the insertion portion comprises a plurality of sealing slots.

12. The pipe connection of claim 11, further comprising an O-ring arranged in each of the plurality of sealing slots.

13. The pipe connection of claim 1, wherein the slip comprises a first slip and a second slip, the first and second slips configured for consecutive longitudinal arrangement.

14. The pipe connection of claim 13, further comprising a cam ring for arrangement within the sleeve and to engage at least one of the first slip and the second slip.

15. The pipe connection of claim 14, wherein the at least one of the first slip and second slip comprises a proximal slip and the cam ring is adapted to slidingly engage the proximal slip.

16. The pipe connection of claim 15, wherein sleeve comprises an internal shoulder adapted to advance the cam ring in a proximal direction.

17. A pipeline for transporting fluid, the pipeline comprising:
a plurality of pipes in fluid communication with one another to transport a fluid;
a pipe connection connecting the pipes at each connection between the plurality of pipes, the connection comprising:
a mandrel comprising an insertion portion configure for inserting into an open end of a pipe and comprising a head;
a slip for bitingly engaging an outer surface of the pipe and having a first tapered portion and a second tapered portion; and
a sleeve having cam surfaces for engaging the first and second tapered portions and a head engaging portion for securing the sleeve to the head.

18. A slip for a pipe connection, the slip comprising:
a substantially cylindrical inner surface adapted for biting into an outside surface of a pipe and having a plurality of teeth; and
an outside surface comprising a proximal tapered portion and a distal tapered portion, the distal tapered portion being offset radially from the proximal tapered portion.

19. The slip of claim 18, wherein the teeth comprise a proximal surface arranged substantially radially and a distal surface angled upward away from the pipe surface and skewed in a distal direction.

20. The slip of claim 18, further comprising a longitudinally extending compression relief slots.
